(19) United States
(12) Patent Application Publication
(10) Pub. No.: US 2025/0336041 A1
(43) Pub. Date: Oct. 30, 2025

(54) SPATIOTEMPORAL CONSISTENCY ORIENTED TRAINING FRAMEWORK FOR AI BASED STABLE VIDEO GENERATION

(71) Applicant: Samsung Electronics Co., Ltd., Suwon-si (KR)

(72) Inventors: Chang Su, Foothill Ranch, CA (US); Chenguang Liu, Tustine, CA (US)

(21) Appl. No.: 19/177,175

(22) Filed: Apr. 11, 2025

Related U.S. Application Data
(60) Provisional application No. 63/638,355, filed on Apr. 24, 2024.

(51) Int. Cl. G06T 5/60; G06T 3/14; G06T 7/246

(52) U.S. Cl. CPC G06T 5/60; G06T 3/14; G06T 7/246

(57) ABSTRACT

A method includes identifying at least one point in a set of image frames within a temporal window. The set of image frames within the temporal window forms video content. The method also includes extracting temporal information including movement of the at least one point through the set of image frames within the temporal window based on estimation of a local motion vector and/or a supervised optical flow represented in the set of image frames. The method further includes generating a video portion based on association of the temporal information with the set of image frames within the temporal window. In addition, the method includes inputting the video portion as at least part of batch training data for one or more generative machine learning models, where the one or more generative machine learning models that are configured by being trained with the video portion generate temporally stable video content.

### CROSS-REFERENCE TO RELATED AND CLAIM OF PRIORITY

This application claims priority under 35 U.S.C. § 119(e) to U.S. Provisional Patent Application No. 63/638,355 filed on Apr. 24, 2024, which is hereby incorporated by reference in its entirety.

### TECHNICAL FIELD

This disclosure relates generally to training generative artificial intelligence (AI) models. More specifically, this disclosure relates to a spatiotemporal consistency oriented training framework for AI based stable video generation.

### BACKGROUND

Image restoration is often useful or important in digital image processing, aiming to improve the appearance or quality of images that have been degraded. Such degradation can occur due to various reasons, such as noise, blur caused by camera shake or focus issues, compression artifacts, and/or resolution. One goal of image restoration can be to revert images back to their original or otherwise non-degraded form or as close thereto as possible.

### SUMMARY

This disclosure relates to a spatiotemporal consistency oriented training framework for artificial intelligence (AI) based stable video generation.

In a first embodiment, a method includes identifying, using at least one processing device of an electronic device, at least one point in a set of image frames within a temporal window, where the set of image frames within the temporal window forms video content. The method also includes extracting, using the at least one processing device, temporal information including movement of the at least one point through the set of image frames within the temporal window based on estimation of at least one of a local motion vector or a supervised optical flow represented in the set of image frames. The method further includes generating, using the at least one processing device, a video portion based on association of the temporal information with the set of image frames within the temporal window. In addition, the method includes inputting, using the at least one processing device, the video portion as at least part of batch training data for one or more generative machine learning models, where the one or more generative machine learning models that are configured by being trained with the video portion generate temporally stable video content.

In a second embodiment, an electronic device includes at least one processing device configured to identify at least one point in a set of image frames within a temporal window, where the set of image frames within the temporal window forms video content. The at least one processing device is also configured to extract temporal information including movement of the at least one point through the set of image frames within the temporal window based on estimation of at least one of a local motion vector or a supervised optical flow represented in the set of image frames. The at least one processing device is further configured to generate a video portion based on association of the temporal information with the set of image frames within the temporal window. In addition, the at least one processing device is configured to input the video portion as at least part of batch training data for one or more generative machine learning models, where the one or more generative machine learning models that are configured by being trained with the video portion generate temporally stable video content.

In a third embodiment, a non-transitory machine readable medium contains instructions that when executed cause at least one processor of an electronic device to identify at least one point in a set of image frames within a temporal window, where the set of image frames within the temporal window forms video content. The non-transitory machine readable medium also contains instructions that when executed cause the at least one processor to extract temporal information including movement of the at least one point through the set of image frames within the temporal window based on estimation of at least one of a local motion vector or a supervised optical flow represented in the set of image frames. The non-transitory machine readable medium further contains instructions that when executed cause the at least one processor to generate a video portion based on association of the temporal information with the set of image frames within the temporal window. In addition, the non-transitory machine readable medium contains instructions that when executed cause the at least one processor to input the video portion as at least part of batch training data for one or more generative machine learning models, where the one or more generative machine learning models that are configured by being trained with the video portion generate temporally stable video content.

Any single one or any combination of the following features may be used with the first, second, or third embodiment. At least one of the local motion vector or the supervised optical flow may be estimated prior to inputting the video portion as at least part of the batch training data for the one or more generative machine learning models. The video portion may be a temporally registered video portion for a training temporal window duration. A training patch included in the batch training data may be configured as a temporal patch, where the temporal patch includes two or more temporally correlated two-dimensional (2D) frame blocks obtained based on the temporally registered video portion. A number of the temporally correlated 2D frame blocks may be an integer that is determined by a frame rate and the training temporal window duration. One or more losses may be identified in a temporal domain, where the one or more losses include one or more temporal consistency losses. The video portion may include a first temporally registered video clip, and the batch training data for the one or more generative machine learning models may include a plurality of temporally registered video clips including the first temporally registered video clip.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration that may be employed for ensuring spatiotemporal consistency in video content produced by generative artificial intelligence (AI) models in accordance with this disclosure;

FIG. 2 illustrates an example process of ensuring spatiotemporal consistency in video content produced by generative AI models in accordance with this disclosure;

FIG. 3 illustrates an example spatiotemporal stability oriented framework for ensuring spatiotemporal consistency in video content produced by generative AI models in accordance with this disclosure;

FIG. 4 illustrates an example process for temporal correlation of video clips for use in model training within the spatiotemporal stability oriented framework of FIG. 3 in accordance with this disclosure; and

FIGS. 5A through 5D illustrate how visual impacts may result from lack of temporal stability of generative AI models.

### DETAILED DESCRIPTION

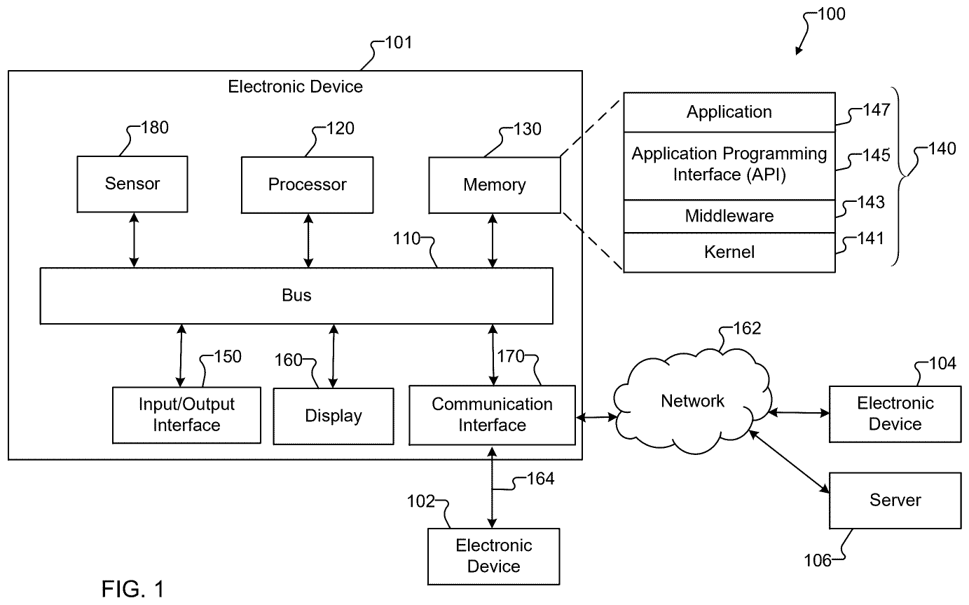

FIGS. 1 through 5B, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, image restoration is often useful or important in digital image processing, aiming to improve the appearance or quality of images that have been degraded. Such degradation can occur due to various reasons, such as noise, blur caused by camera shake or focus issues, compression artifacts, and/or resolution. One goal of image restoration can be to revert images back to their original or otherwise non-degraded form or as close thereto as possible.

Generative artificial intelligence (AI), especially diffusion models, may perform well as deep learning models for image restoration. However, many generative AI models suffer from temporal stability issues. Even worse, for AI models that are very powerful in content recovery or creative content generation (which includes at least some popular generative AI models), the temporal instability issue may become so serious as to lead to high visual impacts, such as temporal flickering, content distortions, and/or color inconsistency. Among other reasons, this temporal instability may be caused by the powerful creative content generation ability of the models. With such powerful content generation abilities, small temporal differences can lead to significant content changes in different frames.

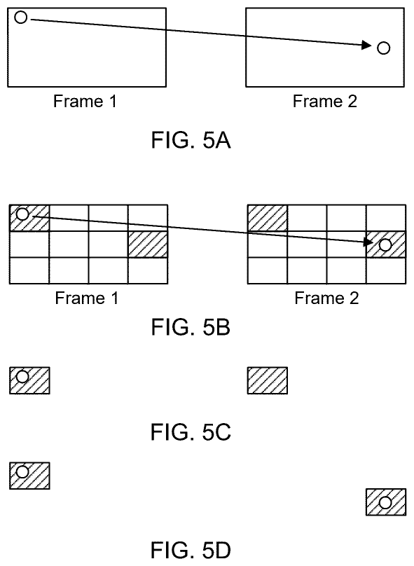

FIGS. 5A through 5D illustrate how visual impacts may result from lack of temporal stability of generative AI models. As shown in FIG. 5A, an object may move from a first location in one frame of video content to a second location in the next frame. Due to costs, video processing model training is generally carried out with batches, each of which includes multiple patches for each frame as shown in FIG. 5B. Without temporally registering patches between frames, geometrically corresponding patches (such as the upper left corners) in neighboring frames may have different contents as shown in FIG. 5C. Losses computed from geometrically corresponding patches may be very different. Temporal registration of video clips involves identifying patches within neighboring frames with the same (or highly similar) content as shown in FIG. 5D. Errors caused by temporal instabilities may be greatly influenced by content differences between predictions and ground truths. A model optimizer is not well-suited to apply effective constraints in order to minimize the influence of different content.

By contrast, with temporally registered patches, one single temporal patch across multiple frames corresponds to multiple spatial patches having similar contents. Either content differences or temporal instabilities may lead to significant loss between the predictions and the ground truths, allowing a model optimizer to apply more effective temporal constraints to a model. To solve the temporal inconsistency problem described above, generative models could adopt either of the following strategies to generate temporally stable contents.
1. Introduce a transformer into an already computationally expensive diffusion model to increase temporal consistency. Since the transformer itself may have a huge number of parameters and is computationally expensive, this approach can effectively increase the temporal consistency but also lead to models that are extremely large in size. For example, a diffusion model for visual quality enhancement may have around 981 million parameters. Such a model may be infeasible to run in, for instance, television (TV) product implementations or other product implementations.
2. Train models with video clips, such as by generating video content clip-wise instead of frame-wise. In such a way, the generated content may have temporal constraints. However, this strategy generally uses three dimensional (3D) convolutions, which can be very expensive computationally. Similar to above approach, this approach may be infeasible to run in TV production implementations or other product implementations.

This disclosure includes an offline spatiotemporal stability oriented (STSO) training framework that is configured to train generative AI models to generate temporally stable video content. With this approach, the generative AI models do not need to be composed of expensive temporal processing components, such as transformer neural network (NN) or 3D temporal convolutions. Using the training framework described below, the framework can (i) retain powerful content creation abilities of a generative AI model (such as a diffusion model) to generate high-quality frames and (ii) avoid significant temporal artifacts in the generated high-quality videos.

In some cases, the approaches described here can introduce effective spatiotemporal losses into training so that large differences between estimations and ground truths (in either the spatial or temporal domain) may lead to large losses. With large losses, training can update the model parameters until both spatial losses and temporal losses are small enough (such as converged). As such, models trained in accordance with this disclosure can have relatively high temporal consistency without using expensive structures like transformer NN or 3D convolutions.

One feature of the spatiotemporal stability oriented training framework in this disclosure is that high losses may be generated when differences between outputs of a generative AI model and the corresponding ground truths are high in either the spatial or temporal domain. High losses in the spatial domain may indicate that the model does not generate high quality content in a frame-wise manner, and high losses in the temporal domain may indicate that the model has low temporal consistency. An optimizer (such as an Adaptive Moment Estimation or “Adam” optimizer) can update the parameters of the model in a direction that decreases the losses in both the spatial and temporal domains.

FIG. 1 illustrates an example network configuration 100 that may be employed for ensuring spatiotemporal consistency in video content produced by generative AI models in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to spatiotemporal consistency oriented training for AI based stable video generation.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to spatiotemporal consistency oriented training for AI based stable video generation. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the electronic device 101 and/or the server 106 may perform various operations related to spatiotemporal consistency oriented training for AI based stable video generation. In some embodiments, for example, the electronic device 101 may be employed to consume content, while the server 106 may be employed to ensure spatiotemporal consistency in video content produced by one or more generative AI models for consumption on the electronic device 101.

Although FIG. 1 illustrates one example of a network configuration 100 including an electronic device 101 employed to ensure spatiotemporal consistency in video content produced by generative AI models, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

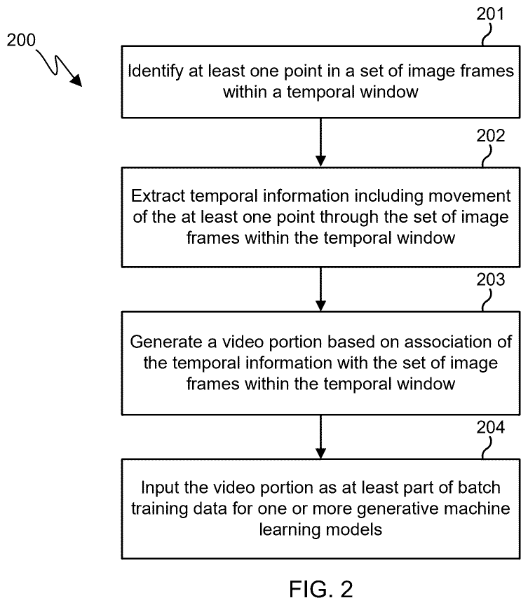

FIG. 2 illustrates an example process 200 of ensuring spatiotemporal consistency in video content produced by generative AI models in accordance with this disclosure. For ease of explanation, the process 200 of FIG. 2 is described as being performed using the server 106 in the network configuration 100 of FIG. 1. However, the process 200 may be performed using any other suitable device(s) (such as the electronic device 101) and in any other suitable system(s).

As shown in FIG. 2, the process 200 begins with identifying at least one point in a set of image frames within a temporal window (step 201). The set of image frames within the temporal window forms video content. For example, one or more points in each of a series of successive image frames within the temporal window may be identified. Temporal information including movement of the at least one point through the set of image frames within the temporal window is extracted (step 202). For instance, the temporal information may be extracted based on estimation of at least one of a local motion vector or a supervised optical flow represented in the set of image frames. Estimation of the at least one of the local motion vector or the supervised optical flow may be performed prior to inputting training data to the one or more generative machine learning models.

A video portion is generated based on association of the temporal information with the set of image frames within the temporal window (step 203). For example, the video portion may be temporally registered for a training temporal window duration. In some cases, the video portion represents a first temporally registered video clip of a plurality of temporally registered video clips. The video portion is input as at least part of batch training data for one or more generative machine learning models (step 204). For example, during training of the one or more generative machine learning models, one or more temporal consistency losses in the temporal domain may be identified and used for training. The one or more generative machine learning models can be configured by being trained with the video portion to generate temporally stable video content. The batch training data may be configured as temporal patches, where each temporal patch includes two or more temporally correlated two-dimensional (2D) frame blocks obtained based on the temporally registered video portion. An integer number of the temporally correlated 2D frame blocks could be determined by a frame rate and the training temporal window duration.

Although FIG. 2 illustrates one example of a process 200 of ensuring spatiotemporal consistency in video content produced by generative AI models, various changes may be made to FIG. 2. For example, while shown as a series of steps, various steps in FIG. 2 could overlap, occur in parallel, occur in a different order, or occur any number of times (including zero times).

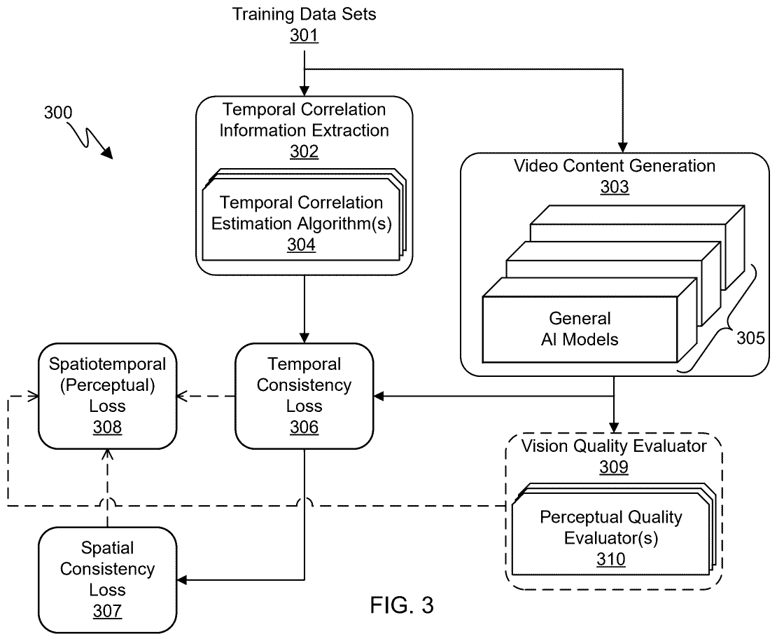

FIG. 3 illustrates an example spatiotemporal stability oriented (STSO) framework 300 for ensuring spatiotemporal consistency in video content produced by generative AI models in accordance with this disclosure. For ease of explanation, the spatiotemporal stability oriented framework 300 of FIG. 3 is described as being implemented within the server 106 in the network configuration 100 of FIG. 1, potentially operating interactively with the electronic device 101 (to which generated video content may be delivered). However, the spatiotemporal stability oriented framework 300 may be implemented using any other suitable device(s) (such as the electronic device 101) and in any other suitable system(s).

As noted above, large losses in the spatial domain may indicate that a generative AI video processing model does not generate frame-wise content of high quality, while large losses in the temporal domain may indicate that the generative AI video processing model has low temporal consistency. A model optimizer (such as the Adam optimizer) can update the parameters of the generative AI video processing model to decrease losses in both the spatial and temporal domains.

As shown in FIG. 3, in some embodiments, the spatiotemporal stability oriented framework 300 may include a dataset branch, a trainer of models, and a spatiotemporal loss branch. In some cases, the spatiotemporal stability oriented framework 300 can be a universal offline training framework. Here, the spatiotemporal stability oriented framework 300 may be suitable for arbitrary end-to-end models. For example, the spatiotemporal stability oriented framework 300 may be operable with any end-to-end models, including models that are only designed for static image generation, by introducing temporal consistency constraints.

In the spatiotemporal stability oriented framework 300 of FIG. 3, solid arrows represent image/video content flow, while dashed arrows represent loss data flow. In this example, training datasets 301 are provided to temporal correlation information extraction 302 and to video content generation 303. In some embodiments, the dataset branch for the spatiotemporal stability oriented framework 300 is in charge of training set preparations. In some embodiments, the training datasets 301 may include both static image content and video content. For static image content, each training patch may represent or include a two dimensional (2D) block. For dynamic video content, each training patch may represent or include a temporal patch containing n temporally correlated 2D frame blocks (which could be obtained by temporal registering video clips), where n is an integer that is determined by the frame rate and the training temporal window has duration t. The spatiotemporal stability oriented framework 300 can use temporally registered video clip content as batch inputs to generative AI models during the spatiotemporal training procedure.

The model trainer comprises a model optimizer (not shown in FIG. 3) and a core for training, namely, a bank 305 of one or more general AI model(s). The term “general AI model” refers to AI models, particularly those configured for image or video processing and often employing generative AI designs, which are not necessarily specifically trained with training data and loss functions accounting for spatiotemporal stability in the output. Due to the size of training datasets and the time and expense involved in model training, spatiotemporal stability is often excluded as a consideration during initial model training, finetuning, and deployment. The spatiotemporal stability oriented framework 300 is suitable for use in retraining or fine tuning an existing AI model. Note that the training core in the spatiotemporal stability oriented framework 300 is flexible and can include any arbitrary model as long as each model is an end-to-end solution.

The training datasets 301 as provided may have no explicit temporal correlation information but can be suitable for training a video processing model. Temporal correlation information extraction 302 may employ one or more temporal correlation estimation algorithms 304. In some cases, various known algorithms may be employed, individually or collectively, such as hierarchical motion estimation, sample exhaustive motion estimation, etc. Video content generation 303 may include a bank 305 of general AI models suitable for image or video processing (often generative AI models). In some cases, various known models may be employed for image or video processing tasks, such as image restoration, color conversion or enhancement, super-resolution, dehazing, and the like. In some embodiments, video content generation 303 may be pre-trained or jointly trained together with the spatiotemporal stability oriented framework 300. Once trained as described below, only video content generation 303 might be deployed, such as to end user devices like the electronic device 101.

In this example, the spatiotemporal loss branch includes three parts, namely temporal consistency loss 306, spatial consistency loss 307, and spatiotemporal (perceptual) loss 308. The output of temporal correlation information extraction 302 and the output of video content generation 303 can be employed to determine temporal consistency loss 306. The temporal loss calculator for temporal consistency loss 306 determines losses in the temporal domain. In some cases, the calculator adopts temporal correlation information from temporal correlation information extraction 302 to estimate the temporal consistency of both the generated content from video content generation 303 and a ground truth and to calculate the losses based on differences. Any suitable loss function(s) may be used here. For instance, various loss functions based on temporal consistency, seeking to reduce or eliminate temporal (time/sequence-based) artifacts such as flicker, jerkiness, floating, or, for compressed video, perceivable encoding artifacts, are known in the art.

The temporal loss function also supports the case that there exists no ground truth(s) for the video training datasets 301. Due to the huge volume of data needed for video processing model training, many training datasets including video content provide no ground truths. In such cases, the temporal loss calculator may determine the temporal consistency from temporally successive contents. As long as input contents are temporally stable, the inputs can also be used as the ground truth for temporal consistency. With the spatiotemporal stability oriented framework 300, temporal losses can be obtained with or without ground truth content, and the results of the model(s) under training may also generate temporally stable content even when the training datasets 301 have no video ground truth.

The outputs of temporal correlation information extraction 302 and video content generation 303, either alone or together with the temporal consistency loss 306, may also be employed to determine spatial consistency loss 307. The spatial loss calculator for spatial consistency loss 307 determines losses in the spatial domain, which represent how similar the results from the model(s) under training (in video content generation 303) correspond to the corresponding ground truths on a frame-wise (or static image wise) basis. The losses can be determined to avoid visible content distortions in each frame of the generated content. Any suitable loss function(s) may be used here. For example, loss functions based on spatial consistency, seeking to reduce or eliminate spatial (location-based) artifacts such as basis pattern effects, blocking, blurring, color bleeding, or ringing, are also known in the art.

One useful or important feature of the spatiotemporal stability oriented framework is that high losses are generated when differences between the outputs of a generative AI model and the ground truths are high in the spatial domain, the temporal domain, or both the spatial and temporal domains. The spatiotemporal loss branch of the spatiotemporal stability oriented framework 300 includes functions for determining spatiotemporal (perceptual) loss 308. The spatiotemporal loss functions adaptively combine the temporal consistency loss 306 and the spatial consistency loss 307 to generate a final loss. With the spatiotemporal loss functions, once large differences appear between the generated contents and the respective ground truths in one or both of the temporal domain and the spatial domain, the spatiotemporal loss functions lead to a high final loss during the corresponding training iteration. With the functions for determining spatiotemporal (perceptual) loss 308 in the spatiotemporal stability oriented framework 300, each frame of the generated content generated by the trained video content generation 303 is very high quality (such as very fine details, crystal clear contrast and vivid colors, etc.). Notably, if temporal consistency between consecutive generated frames is low, the final losses can still be high. Thus, the spatiotemporal stability oriented framework 300 can further optimize the model(s) under training to achieve high temporal consistency.

To make the bank 305 of models under training in the spatiotemporal stability oriented framework 300 generate results that are more suitable for human vision, the spatiotemporal stability oriented framework 300 can optionally also introduce perceptual losses into the computations of the spatiotemporal (perceptual) loss 308. This may be achieved with an optional vision quality evaluator 309, which can include a bank 310 of perceptual quality evaluator(s). With optional perceptual loss included within the spatiotemporal (perceptual) loss 308, cases where the trainer may blur some fine details or sacrifice some contrast to achieve high temporal consistency may be avoided.

Although FIG. 3 illustrates one example of a spatiotemporal stability oriented framework 300 for ensuring spatiotemporal consistency in video content produced by generative AI models, various changes may be made to FIG. 3. For example, while depicted separately, any combination of the temporal consistency loss 306, the spatial consistency loss 307, and/or the spatiotemporal (perceptual) loss 308 may be determined conjointly or collaboratively.

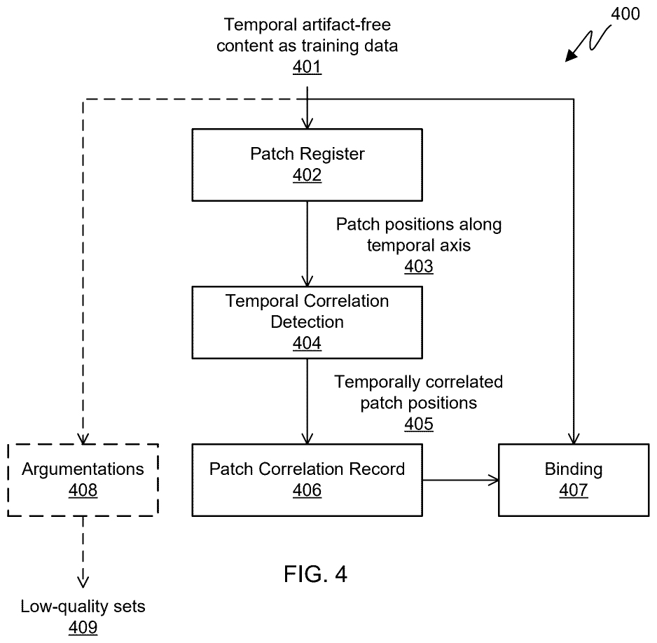

FIG. 4 illustrates an example process 400 for temporal correlation of video clips for use in model training within the spatiotemporal stability oriented framework 300 of FIG. 3 in accordance with this disclosure. The process 400 may, for example, represent an example of how the temporal correlation information extraction 302 may be performed.

In some video clip-based training, each value clip within the training dataset(s) is directly used in training. In this disclosure, temporally correlated training data can be determined on-the-fly, online, or off-line. Temporally correlated training data can greatly enhance the temporal constraints that are applied to the model(s) under training, even when the model(s) may not have temporal structures. If a generative AI model is temporally stable, the generated content from inputs can have similar temporal correlations as the corresponding ground truths (the inputs can also be used as the ground truths if those inputs are temporally stable), which leads to low temporal loss. With temporally registered (correlated) training data, each 2D patch in a temporal patch (see, e.g., equation (1) below) has similar content. If an AI model is not temporally stable, and generates big changes from small temporal changes, the model will reflect high losses since each 2D patch in the temporal ground-truth patch has similar and stable contents. With such high losses, an optimizer can effectively punish the model. That is, temporally correlated training data adds effective constraints to an AI model on temporal creativity even the model has no temporal structure (for example, a super-resolution model trained with temporally uncorrelated datasets may generate crystal clear static images but very flickering video content, but after being fine-tuned with temporally correlated datasets will generate very stable video content. FIG. 4 shows an example process 400 that generates temporally correlated training data.

As shown in FIG. 4, the process 400 begins with receiving temporal artifact-free content as training data 401. The training data 401 may be all or part of training dataset 301 and may or may not be original content captured for that purpose (such as uncompressed video capture by at least one ultra high resolution camera). Certain image quality issues, such as color accuracy or dynamic range, may be irrelevant for the purposes of the process 400.

The training data 401 is input to a patch register 402. To extract temporal information (such as optical flow) from temporally correlated content (such as a set of successive frames in a temporal window), contents of any patches can be temporally correlated to the content of other patches. See the discussion of FIG. 5A through 5D above. The patch register 402 outputs patch positions 403 along a temporal axis having time indices t. Those patch positions 403 can be employed by temporal correlation detection 404 to determine temporally correlated patch positions 405 based on location x within respective frames ƒ₀, ƒ₁. The temporally correlated patch positions 405 collectively form a patch correlation record 406, which can be used by binding 407 that associates the temporally correlated patch positions 405 in the patch correlation record 406 with the training data 401.

In some cases, operation of the patch register 402 and temporal correlation detection 404 may occur as follows. Let p(x) represent a point at location x in the current frame fₜ, where t represents the center temporal index of a given temporal window containing a set of frames {ƒ₋ₙ, . . . , ƒ₋₁, ƒ₀, ƒ₊₁, . . . , ƒ₊ₙ}. The point p(x) has motions during the temporal window with motion vectors (or optical flow) {v₋ₙ, . . . , v₋₁, v₀, . . . , v₊ₙ}. Note that the center frame ƒ₀ is made the temporal registration reference frame, so the motion vector of point p(x) in frame ƒₜ is zero. Without losing generality, however, a reference frame can be the frame at an arbitrary temporal index. For example, the last frame of the temporal window may be taken as the current temporal registration reference frame.

Temporally registering a point p(x) in the given temporal window may be defined as locating the corresponding point, denoted \tilde{p}ₜ(x), to point p(x) in the frame with an arbitrary temporal index t. For example, once motion vectors or optic flows have been calculated, the corresponding point at t may be located as follows.

$${\tilde{p}}_{t} ( x ) = {f}_{t} ( x + {\sum }_{i = 0}^{t} {v}_{i} )$$

As can be seen from the equation above, in a given temporal window, with motions (either motion vectors of blocks or optimal flows), the temporally registered content (such as a point p(x)) in the reference frame may be represented as follows.

$$\{ {\tilde{p}}_{- n} ( x ) , … , {\tilde{p}}_{- 1} ( x ) , {\tilde{p}}_{0} ( x ) , {\tilde{p}}_{+ 1} ( x ) , … , {\tilde{p}}_{+ n} ( x ) \} \qquad ( 1 )$$

These temporally correlated points can be aggregated in the patch correlation record 406. Optionally, the process 400 may employ argumentations 408 to analyze and resolve conflicting data within the training data 401, producing low-quality sets 409 of patch correlation records.

Although FIG. 4 illustrates one example of a process 400 for temporal correlation of video clips for use in model training within the spatiotemporal stability oriented framework 300 of FIG. 3, various changes may be made to FIG. 4. For example, while depicted as operating successively, the patch register 402 and the temporal correlation detection 404 may operate in an overlapping or parallel pipelined manner.

Various embodiments of this disclosure can include (but are not limited to) a spatiotemporal stability oriented model training framework configured to adopt a temporal loss function to enforce one or more neural network models or other machine learning models to follow temporal consistency during training, instead of maintaining temporal consistency by the model(s) (such as by adopting expensive 3D convolution or temporal layers in NN structures). Thus, the embodiments of this disclosure of this disclosure may decrease the costs of model training while increasing feasibility of commercialization of models, making these embodiments suitable for building product-oriented generative AI models for generating creative content (which are typically very large).

As noted above, video ground truths may not be available in some instances, such as due to the large size of the training datasets. In such cases, the temporal loss function of this disclosure allows users to use the input content as “ground truths.” If the input content is sufficiently temporally stable, the temporal loss function can still apply strong enough constraints to the model(s) under training. As a particular example use case, this is suitable for the application of converting standard dynamic range (SDR) content to high dynamic range (HDR) content, where the SDR content items themselves are usually adequately stable temporally. This feature greatly increases the robustness and flexibility of the disclosed technology's training framework.

As mentioned above, with the training framework and the temporal loss function of this disclosure, strong temporal constraints may be applied to arbitrary models, whether or not the models have temporally stable structures (usually referred to as temporal layers). With the training framework, generative AI models can be freed from computationally expensive temporal structures and therefore become more feasible without losing high temporal consistency.

Example use cases of the spatiotemporal training framework of this disclosure can include (but are not limited to):
High-quality HDR content generation from low-quality SDR content
Visual quality enhancement
Super-resolution
Text-to-video generation
Prompt based video content revision
Any end-to-end generative AI-based image/video content generation/revision

In some embodiments, a training framework (such as an offline training framework) can cope with challenging temporal problems in generative AI-based image and video processing applications. For example, a spatiotemporal framework having one or more temporal information extraction components may be employed to model temporal information offline or online/on-the-fly during training. Based on the temporal information extracted from the temporal information extraction components, temporal consistency may be computed as temporal losses, which can be applied as strong temporal constraints to the AI model(s) under training. The AI model(s), including those without temporal structures such as 3D convolutions or temporal layers, can learn image features that are prone to temporal artifacts (such as flickering, aliasing, unstable colorization, etc.) and learn to reduce such temporal artifacts. After the (such as offline) training, AI model(s), such as expensive generative models, may be trained for temporally stable inferencing without needing a temporal processing structure, which greatly reduces computational power and hardware costs.

In some embodiments, temporal losses based on temporal consistency may be calculated using patches that, in each batch, become temporally registered patches. Each temporal patch may include any suitable number of temporally correlated spatial patches. In this way, not only can effective temporal constraints for training spatiotemporal stable networks be obtained, but the temporal constraints can be obtained with or without ground truth content (especially if the inputs are temporally stable).

Based on this disclosure, temporal information (such as optical flows or local motion vectors) may be extracted from temporally correlated content (such as a set of successive frames in a given temporal window) to generate training datasets. Temporal registration (which may be achieved using the equation(s) above) can be used to represent, identify, and/or locate a point (such as a point of interest) in a particular frame at a given time within a given temporal widow. Thus, temporally registering a set of frames can represent how each point in each frame moves across the set of frames in the given temporal window. These temporally registered frames can subsequently be used as training data. Note that the phrases “temporal registration” of “temporally registering” are similar to “temporal training data extraction” and involve preparing one or more training datasets with extra temporal information as additional training input(s) to a neural network or other machine learning model(s). Basically, the training pairs may be “input video+temporal information extracted (such as optical flows)” and “ground truth video” (either an actual separate input or the same input if sufficiently temporally stable), with the result of the training being prediction of an output within a defined loss function of the ground truth video.

Note that the embodiments described in connection with FIGS. 2 through 4 may be employed in any combination of the features disclosed for any individual embodiment. Thus, features described with respect to one embodiment may be used in a different embodiment.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
identifying, using at least one processing device of an electronic device, at least one point in a set of image frames within a temporal window, wherein the set of image frames within the temporal window forms video content;
extracting, using the at least one processing device, temporal information including movement of the at least one point through the set of image frames within the temporal window based on estimation of at least one of a local motion vector or a supervised optical flow represented in the set of image frames;
generating, using the at least one processing device, a video portion based on association of the temporal information with the set of image frames within the temporal window; and
inputting, using the at least one processing device, the video portion as at least part of batch training data for one or more generative machine learning models, wherein the one or more generative machine learning models that are configured by being trained with the video portion generate temporally stable video content.

2. The method of claim 1, wherein at least one of the local motion vector or the supervised optical flow is estimated prior to inputting the video portion as at least part of the batch training data for the one or more generative machine learning models.

3. The method of claim 1, wherein the video portion is a temporally registered video portion for a training temporal window duration.

4. The method of claim 3, further comprising:
configuring a training patch included in the batch training data as a temporal patch, the temporal patch including two or more temporally correlated two-dimensional (2D) frame blocks obtained based on the temporally registered video portion.

5. The method of claim 4, wherein a number of the temporally correlated 2D frame blocks is an integer that is determined by a frame rate and the training temporal window duration.

6. The method of claim 1, further comprising:
identifying one or more losses in a temporal domain, wherein the one or more losses comprise one or more temporal consistency losses.

7. The method of claim 1, wherein:
the video portion comprises a first temporally registered video clip; and
the batch training data for the one or more generative machine learning models comprises a plurality of temporally registered video clips including the first temporally registered video clip.

8. An electronic device, comprising:
at least one processing device configured to:
identify at least one point in a set of image frames within a temporal window, wherein the set of image frames within the temporal window forms video content;
extract temporal information including movement of the at least one point through the set of image frames within the temporal window based on estimation of at least one of a local motion vector or a supervised optical flow represented in the set of image frames;
generate a video portion based on association of the temporal information with the set of image frames within the temporal window; and
input the video portion as at least part of batch training data for one or more generative machine learning models, wherein the one or more generative machine learning models that are configured by being trained with the video portion generate temporally stable video content.

9. The electronic device of claim 8, wherein the at least one processing device is configured to estimate at least one of the local motion vector or the supervised optical flow prior to inputting the video portion as at least part of the batch training data for the one or more generative machine learning models.

10. The electronic device of claim 8, wherein the video portion is a temporally registered video portion for a training temporal window duration.

11. The electronic device of claim 10, wherein the at least one processing device is configured to configure a training patch included in the batch training data as a temporal patch, the temporal patch including two or more temporally correlated two-dimensional (2D) frame blocks obtained based on the temporally registered video portion.

12. The electronic device of claim 11, wherein a number of the temporally correlated 2D frame blocks is an integer that is determined by a frame rate and the training temporal window duration.

13. The electronic device of claim 8, wherein the at least one processing device is configured to identify one or more losses in a temporal domain, the one or more losses comprising one or more temporal consistency losses.

14. The electronic device of claim 8, wherein:
the video portion comprises a first temporally registered video clip; and
the batch training data for the one or more generative machine learning models comprises a plurality of temporally registered video clips including the first temporally registered video clip.

15. A non-transitory machine readable medium containing instructions that when executed cause at least one processor of an electronic device to:
identify at least one point in a set of image frames within a temporal window, wherein the set of image frames within the temporal window forms video content;
extract temporal information including movement of the at least one point through the set of image frames within the temporal window based on estimation of at least one of a local motion vector or a supervised optical flow represented in the set of image frames;
generate a video portion based on association of the temporal information with the set of image frames within the temporal window; and
input the video portion as at least part of batch training data for one or more generative machine learning models, wherein the one or more generative machine learning models that are configured by being trained with the video portion generate temporally stable video content.

16. The non-transitory machine readable medium of claim 15, wherein the instructions when executed cause the at least one processor to estimate at least one of the local motion vector or the supervised optical flow prior to inputting the video portion as at least part of the batch training data for the one or more generative machine learning models.

17. The non-transitory machine readable medium of claim 15, wherein the video portion is a temporally registered video portion for a training temporal window duration.

18. The non-transitory machine readable medium of claim 17, wherein the instructions when executed cause the at least one processor to configure a training patch included in the batch training data as a temporal patch, the temporal patch including two or more temporally correlated two-dimensional (2D) frame blocks obtained based on the temporally registered video portion.

19. The non-transitory machine readable medium of claim 18, wherein a number of the temporally correlated 2D frame blocks is an integer that is determined by a frame rate and the training temporal window duration.

20. The non-transitory machine readable medium of claim 15, wherein the instructions when executed cause the at least one processor to identify one or more losses in a temporal domain, the one or more losses comprising one or more temporal consistency losses.
